(19) United States
(12) Patent Application Publication
(10) Pub. No.: US 2026/0270929 A1
(43) Pub. Date: Sep. 10, 2026

(54) METHODS, ARCHITECTURES, APPARATUSES, AND SYSTEMS FOR DISCOVERING SENSING DEVICES IN A WIRELESS NETWORK

(71) Applicant: InterDigital Patent Holdings, Inc., Wilmington, DE (US)

(72) Inventors: Filipe Conceicao, London (GB); Sebastian Robitzsch, London (GB); Laksh Bhatia, London (GB); Muhammad Awais Jadoon, London (GB); Michael Starsinic, Newtown, PA (US)

(21) Appl. No.: 19/075,390

(22) Filed: Mar. 10, 2025

(51) Int. Cl. H04W 64/00; H04W 8/22; H04W 68/02

(52) U.S. Cl. CPC H04W 64/00; H04W 8/22; H04W 68/02

(57) ABSTRACT

Procedures, methods, architectures, apparatuses, systems, and devices are provided for discovering sensing devices in wireless networks. A method performed by a wireless transmit/receive unit (WTRU) includes operating in a first state during which location information is not communicated by the WTRU to a wireless network, receiving, while operating in the first state, a message from the wireless network, based on receiving the message, operating in a second state for generating the location information indicating a location of the WTRU, transmitting the location information to the wireless network, and transmitting sensing availability information to the wireless network, receiving a request from the wireless network, wherein the request was generated based on the sensing availability information, performing sensing operations based on the request to generate sensing data, and transmitting the sensing data to the wireless network.

### TECHNICAL FIELD

The present disclosure is generally directed to the fields of communications, hardware, software and encoding, including, for example, to methods, architectures, apparatuses, and systems related to discovering sensing devices in wireless networks. The sensing devices (i.e., sensors, transmitters, receivers, or any other suitable device) include, but are not limited to, at least one wireless transmit/receive unit (WTRU).

### BACKGROUND

There is interest in developing sensing features as part of the capabilities of wireless networks.

If implemented as a new feature, sensing could require new system functionalities, which could be supported by mobile network systems. These functionalities may be enabled by sensors and/or functions of a core network. These functionalities can be embedded in current existing network infrastructure, or in expressly-defined entities (which may or may not be new).

### SUMMARY

Problems addressed in this disclosure may relate to any wireless domain, with or without the framework of a standardized network system. Certain embodiments of this disclosure may include functionalities (e.g., as may be performed by network functions executing on any suitable device) that are fundamentally described based on the objectives they serve, rather than based on their physical implementation (e.g., with respect to hardware of a wireless network) or their possible interaction(s) with other nodes/devices of a wireless network.

For illustrative purposes only, certain descriptions provided herein may use terms associated with current (e.g., fifth generation or 5G, or any other current wireless system) network specifications.. Despite some use of terms associated with current network specifications, embodiments of the present disclosure may be agnostic to any particular set of network specifications (e.g., they may apply to 5G systems, non-standardized wireless network systems, future wireless network systems, any other wireless network, or any combination thereof).

For illustrative purposes, some definitions are provided herein. These definitions include Tracking Areas (TA) and Radio Based Notification areas (RNA). Each of a TA and an RNA includes at least one radio cell. A TA is typically bigger than an RNA, and an RNA is typically more than one radio cell. A positioning framework defines certain representative processes for accurately locating a UE, e.g., based on GPS coordinates. Single or groups of radio cells represent levels of granularity for determining location information of a UE. TAs and/or RNAs are generally described with reference to at least one particular TA or RNA serving the radio cell of a target UE (e.g., where the target UE may be a focus of sensing operations executed by the wireless network).

In connection with certain representative embodiments of this disclosure, a WTRU may be operating in a state (e.g., an inactive or idle state) in which location information is not actively being communicated to a wireless network. However, there may be a request for the wireless network to perform sensing measurements on a target near the WTRU (e.g., within a measurement range of at least one sensor of the WTRU). With the network being unaware of the precise location (e.g., within a specific radio cell) of the WTRU, the WTRU may be able to receive a broadcast signal and report back a sensing availability. Information of the broadcast signal may cause the WTRU to switch to operating in a second state which includes transmitting location information and sensing capabilities to the network. Upon receiving a request from the network, the WTRU may perform sensing operations and transmit the sensing data to the wireless network.

Procedures, methods, architectures, apparatuses, systems, and devices are provided for discovering sensing devices in wireless networks. A method performed by a wireless transmit/receive unit (WTRU) includes operating in a first state during which location information is not communicated by the WTRU to a wireless network, receiving, while operating in the first state (e.g., an inactive or idle state, or any other comparable state), a message from the wireless network, based on receiving the message, operating in a second state (e.g., a connected state, or any other comparable state) for generating the location information indicating a location of the WTRU, transmitting the location information to the wireless network, and transmitting sensing availabilityinformation to the wireless network, receiving a request from the wireless network, wherein the request was generated based on the sensing availabilityinformation, performing sensing operations based on the request to generate sensing data, and transmitting the sensing data to the wireless network.

In certain representative embodiments, operating in the first state includes operating within a cell coverage area of the wireless network while not actively providing the location information to the wireless network.

In certain representative embodiments, the message includes a paging indication including at least one of: a location information configuration, a sensing task requirement, or a sensing task identification (ID).

In certain representative embodiments, the sensing availability information includes a paging triggered report including at least one of: a sensing area requirement, a sensing source requirement, a sensing mode requirement, a sensing range requirement, a sensing task identification (ID), or an ID of the WTRU.

In certain representative embodiments, the WTRU receives the message from the wireless network based on being within a tracking area (TA), the tracking area comprising at least one cell coverage area.

In certain representative embodiments, the WTRU also determines, based on information of the message, that the WTRU can participate in a sensing task, where transmitting the sensing availability information includes communicating the determination that the WTRU can participate in the sensing task.

In certain representative embodiments, information of the message incudes an indication of a target to be sensed, and the sensing availability information may include a distance between the WTRU and the target.

In certain representative embodiments, performing the sensing operations includes providing data from a radiofrequency (RF) sensor, video sensor, or light detection and ranging (LiDAR) sensor of the WTRU.

In certain representative embodiments, performing the sensing operations includes calculating a confidence level associated with accuracy of the sensing data.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system, in accordance with some embodiments of this disclosure;

FIG. 1B is a system diagram illustrating an example wireless transmit and/or receive unit (WTRU) that may be used within the communications system illustrated in FIG. 1A, in accordance with some embodiments of this disclosure;

FIG. 1C is a system diagram illustrating an example radio access network (RAN) and an example core network (CN) that may be used within the communications system illustrated in FIG. 1A, in accordance with some embodiments of this disclosure;

FIG. 1D is a system diagram illustrating a further example RAN and a further example CN that may be used within the communications system illustrated in FIG. 1A, in accordance with some embodiments of this disclosure;

FIG. 2 is a pair of illustrative block diagrams of components implementing the features of a sensing coordination function and a sensing analytics function, in accordance with some embodiments of this disclosure;

FIG. 3 is an illustrative system diagram of a wireless network architecture, in accordance with some embodiments of this disclosure;

FIG. 4 is an illustrative diagram of WTRUs operating in various states around a target UE in accordance with some embodiments of this disclosure;

FIG. 5 is a flow diagram of an illustrative process for discovering a user equipment (UE) that is not actively sharing its location information to a wireless network, and then causing that UE to perform sensing operations, in accordance with some embodiments of this disclosure;

FIG. 6 is a flow diagram of an illustrative process for prioritizing UEs to use in a sensing task, in accordance with some embodiments of this disclosure;

FIG. 7 is a flow diagram of an illustrative process for discovering UEs in the absence of a location management function (LMF), in accordance with some embodiments of this disclosure; and

FIG. 8 is a flow diagram of an illustrative process for sensing using a WTRU based on receiving a message from a wireless network while the WTRU is not actively communicating a location to the wireless network, in accordance with some embodiments of this disclosure.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known processes, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

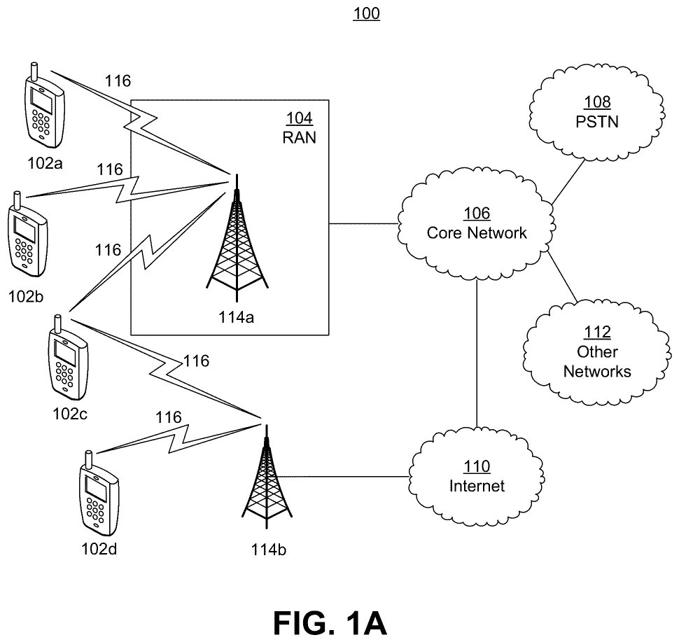

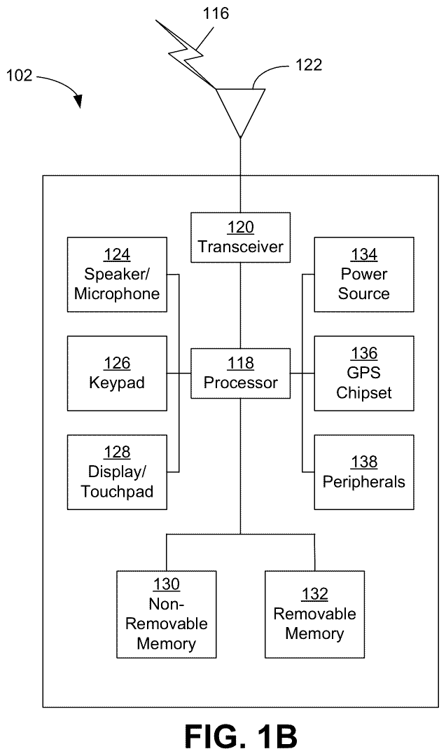

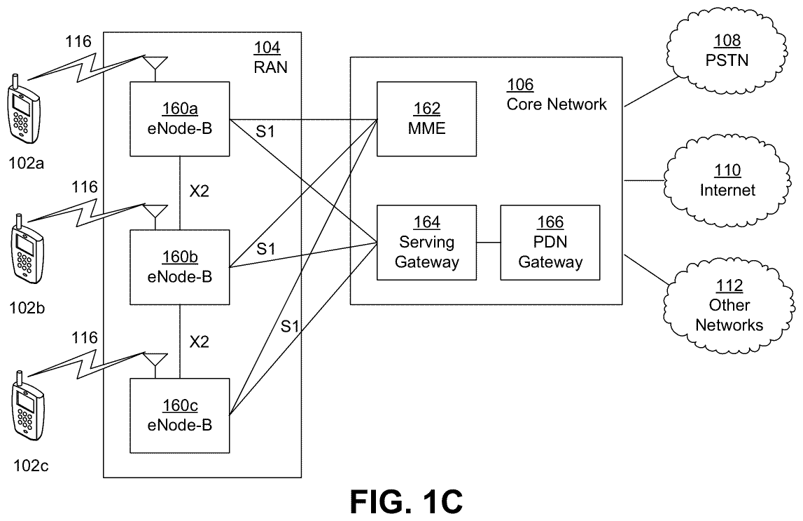

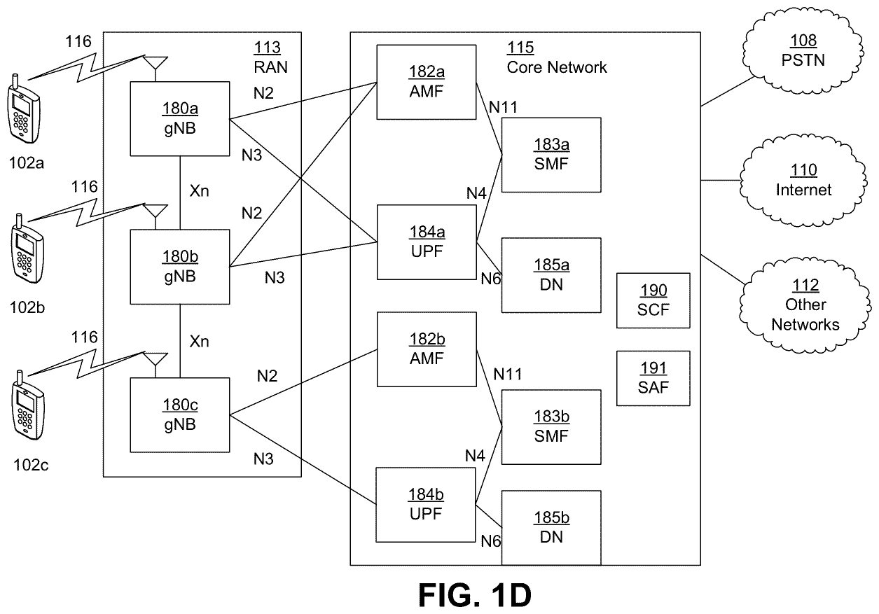

The processes, apparatuses and systems provided herein are well-suited for communications involving both wired and wireless networks (which may be referred to more succinctly as networks). An overview of various types of wireless devices and infrastructure is provided at least in connection with FIGS. 1A-1D, where various elements of the network may utilize, perform, be arranged in accordance with and/or be adapted and/or configured for the processes, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access processes, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit and/or receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE, and vice versa.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable radio access technology (RAT) for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination process while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast Fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, at least one Data Network (DN) 185a, 185b, at least one sensing coordination function (SCF) 190, and at least one sensing analytics function (SAF) 191. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

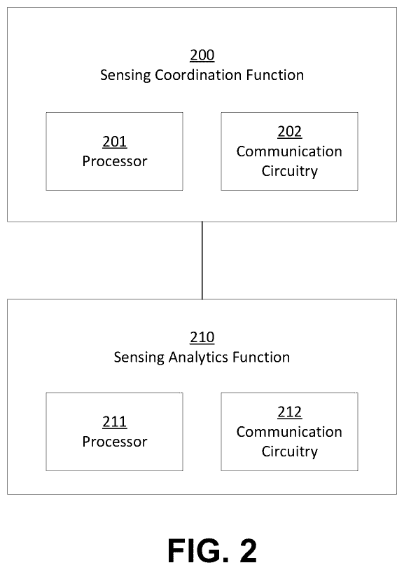

In view of the descriptions provided in connection with FIGS. 1A-1D, and further in view of the following descriptions provided in connection with FIGS. 2-8, it will be understood that a wireless network may include any suitable components and devices, including, for example, any of one or more base stations, one or more TRPs, one or more gNBs, one or more WTRUs, any other suitable device or component, or any combination thereof. It will be further understood that a component or device that is part of the wireless network can be referred to as communicating with the wireless network when it is communicating with any one or more other components or devices of the wireless network. For example, reference to a WTRU, which is part of the wireless network, transmitting or receiving signals to or from the wireless network refers to the WTRU transmitting or receiving signals, respectively, to or from any other component or device (e.g., another WTRU) of the wireless network.

In view of the descriptions provided in connection with FIGS. 1A-1D, and further in view of the following descriptions provided in connection with FIGS. 2-8, a node (e.g., of a wireless network) may generally refer to any physical component that communicates with any other physical component of a wireless network. For example, any physical component performing functions of the RAN or CN may be a node, a gNB may be a node, an eNB may be a node, a WTRU may be a node, a base station may be a node, a DNS server may be a node, and any other equipment configured to communicate with and/or provide a function of the wireless network may be a node. A node may be used interchangeably with an entity or device of the wireless network. In some instances, multiple aspects of the wireless network (e.g., a DNS server and equipment providing at least one function of the network, equipment providing multiple functions of the wireless network, or equipment providing multiple instances of a single function of the wireless network) may be collocated at a single node.

In view of the descriptions provided in connection with FIGS. 1A-1D, and further in view of the following descriptions provided in connection with FIGS. 2-8, certain definitions may be used.

Sensing data may refer to data that is derived from radio signals that are impacted (e.g., reflected, refracted, diffracted) by an object or environment of interest for sensing purposes. Sensing data may be used for sensing purposes, and optionally may be processed at any UE or at any node of a 5G system, of any system operating under a current or future wireless standard, of any non-standardized wireless system, or of any other suitable wireless network.

Sensing data may also refer to data provided by additional sensors (e.g., video, LiDAR, sonar, audio, environmental data, inertial data, location data, any other suitable data, or any combination thereof) about an object or environment of interest for sensing purposes.

A sensing result may include processed sensing data, e.g., that is requested by an operator of the wireless network (e.g., a service consumer, or any suitable entity acting on behalf of the service customer).

A sensing group may refer to a set of sensing transmitters and sensing receivers (collectively, sensing devices) with known locations. Sensing data may be collected synchronously from sensing devices of a sensing group.

A target sensing service area (TSSA) may refer to a location area (e.g., defined in cartesian coordinates) that can be sensed by deriving characteristics of the environment (and/or of objects within the environment) based on certain sensing data. Within the sensing data, certain characteristics of the environment may be indicated by impacted (e.g., reflected, refracted, diffracted, or otherwise influenced by the environment and/or objects within the environment) radio signals. A TSSA may include indoor or outdoor environments, or both. The TSSA can be represented by any combination of values in a one or more coordinate system, e.g., a sequence of GPS coordinates, a function that represents any 2D or 3D shape, a set of points on a function, any other suitable representation, or any combination thereof.

In certain embodiments, a TSSA could be described based on the information provided in the Technical Specification 3rd Generation Partnership Project; Technical Specification Group Services and System Aspects; Universal Geographical Area Description (GAD).

As used herein, a sensing mode may refer to monostatic, bi-static, or multi-static sensing, regardless of the sensing transmitter and receiver pair. For example, in a setup with a UE and a base station (BS), or in a setup with multiple UEs (e.g., including UE1 and UE2), both the UE and the BS, or both UEs, can function as a transmitter or as a receiver.

As used herein, sensing reporting may refer to the transmission of a report containing sensing data, results generated based on sensing data, contextual information (e.g., related to the collection or processing of sensing data), any other information based on a prior or ongoing sensing task, or any combination thereof. Sensing reporting may transmit raw data, processed data, or both.

FIG. 2 is a pair of illustrative block diagrams of components implementing the features of a sensing coordination function and a sensing analytics function, in accordance with some embodiments of this disclosure. FIG. 2 is used to illustrate certain functionalities, e.g., which are named the sensing coordination function 200 and the sensing analytics function 210, for ease of illustration. Their illustration and naming need not define them as new or particular mobile network entities. That is, sensing coordination function 200 and/or sensing analytics function 210 can be embedded in current or newly defined entities of a wireless network. The focus of this invention is to describe the functionalities that these functions serve. These functions need not be defined by their execution at a particular node of a wireless network, nor based on any other networks/devices of the wireless network with which these functions interact.

Sensing coordination function (SCF) 200 includes at least processor 201 and communication circuitry 202. Sensing analytics function (SAF) 210 includes at least processor 211 and communication circuitry 212. SCF 200 (which may correspond to SCF 190) and SAF 210 (which may correspond to SAF 191) can be coupled to each other, as shown, or can operate independent of the other. The processors of FIG. 2 may be configured to process the contents of incoming messages (e.g., as received from a WTRU or from any component of a core network) and generate outgoing messages (e.g., as may be sent to a WTRU or any component of a core network). The communication circuitry of FIG. 2 may be configured to receive any incoming messages and transmit any outgoing messages. The respective functions shown in FIG. 2 may also include, or be coupled to, memory and any other physical components as may be needed to support the operations of the respective processors and communication circuitries.

SCF 200 coordinates the sensing operation in cellular networks. This coordination may include full or partial management of sensing sources of sensing data, other sensing data, sensing results, and sensing contextual information, including source selection, activation, de-activation, configuration and activation/de-activation of reporting from sources. These sources may be an individual sensing transmitter, individual sensing receiver, or a sensing group. SCF 200 manages as well the activation/de-activation and/or switching of sensing modes.

Based on the collected sensing data and/or results, the SAF 210 performs analytics on the sensing data, on the sensing results, or on both, and thus is capable of generating additional sensing data, sensing results, and sensing contextual information. SAF 210 can further generate insights over sensing data, results or contextual information, e.g., by means of the application of general-purpose or application-specific statistical, probabilistic, or AI/ML models. Furthermore, the SAF 210 can perform fusion of sensing data from multiple sources, i.e., SAF 210 can combine different sensing data, results or contextual information from any sensing source and generate further data from that fusion process. SAF 210 may be configured to share the gathered or generated information with application servers in a Data Network (DN), e.g., via the Network Exposure Function (NEF), and/or to an Application Function (AF), or to system-internal components, e.g. other network functions (NFs), UEs or BSs.

To reiterate, though the SCFs of FIG. 1D and FIG. 2 are shown as being distinct from other network functions, the functions of the SCF may be incorporated into any suitable one or more other network functions; the same is true of the SAFs of FIG. 1D and FIG. 2. In any suitable wireless system, there may or may not be specific functions dedicated to performing tasks that are ascribed herein to an SAF or an SCF.

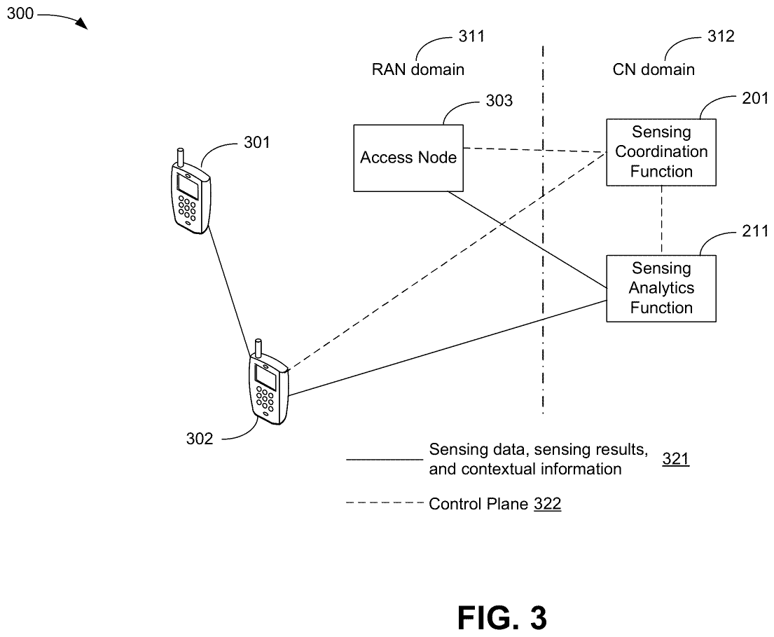

FIG. 3 is an illustrative system diagram of a wireless network architecture 300, in accordance with some embodiments of this disclosure. FIG. 3 shows how WTRUs 301 and 302 (e.g., which may correspond to any WTRUs referenced in this disclosure), and access node 303, may interact with SCF 201 and SAF 211. Network architecture 300 is demarcated into a RAN domain 311 and a CN domain 312 (e.g., which may respectively correspond to any RAN or CN referenced in this document).

Access node 303 may include any radio access node (e.g. regardless of the particular wired or wireless technology connecting the radio access node to the CN domain). Access node 303 can itself be a WTRU, e.g., in the case of UE-to-CN relay functionality.

In FIG. 3, SCF 201 and SAF 211 are shown as being executed within CN domain 312, but they could be executed within RAN domain 311. In certain representative embodiments, either or both of SCF 201 and SAF 211 may be executed at a WTRU.

FIG. 3 depicts certain illustrative data flows through network architecture 300. Via the lined connections, sensing data, results, and/or contextual information 321 are shared. These data can be generated at and transmitted by any WTRU to SAF 211, as shown. Via the dashed connections, control plane data 322 are shared. That is, SAF 201 and SCF 211 have means to communicate with each other, and SCF 201 has means of communicating with access node 303, e.g., for the purpose of the exchange of information related to executing any one or more of the processes described in this disclosure, or related embodiments thereof.

In certain representative embodiments of this disclosure, the wireless network (e.g., including through execution at a WTRU) is configured to identify sensing capabilities of UEs close to a target UE and to execute sensing based on the identification. The sensing may be based on a sensing group (i.e., including sensing data from at least two UEs), and certain representative embodiments of this disclosure may include determining a sensing group. The sensing group may be determined based on pinning an area to be sensed to a WTRU.

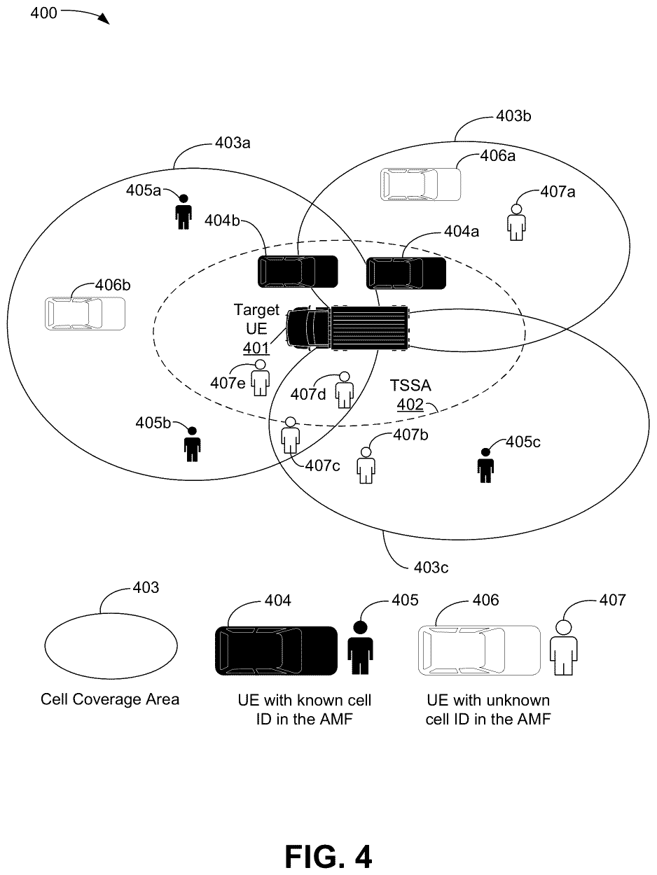

FIG. 4 is an illustrative diagram of WTRUs operating in various states around a target UE in accordance with some embodiments of this disclosure. Every UE shown in FIG. 4 may be regarded as a WTRU. FIG. 4 depicts an illustrative scenario 400 related to certain representative embodiments of this disclosure. In FIG. 4, there is a target UE 401, a TSSA 402, three respective cell coverage areas 403 (i.e., cells 403a-403c), and several UEs, including UEs with known locations (i.e., UEs 404a-b and UEs 405a-c) UEs and UEs with unknown locations (i.e., UEs 406a-b and 407a-de). The UE locations may be known or unknown by a CN including at least one of the cell coverage areas 403. For example, the CN may know or not know the location based on execution of the AMF, any related function, or any combination thereof.

In the illustrative depiction of FIG. 4, the TSSA 402 is pinned to the target UE 401. That is, target UE 401 moves, then TSSA 402 moves with it. Though depicted as an oval, TSSA 402 can have any shape and size. A TSSA 402 may or may not contain a target UE 401.

In connection with scenario 400, a wireless network may obtain sensing results (e.g., based on one or more UEs generating the sensing results) related to TSSA 402. To provide these sensing results, any of the UEs shown in FIG. 4 (any of which may compose a sensing group, e.g., that is available for sensing of TSSA 402) may be used (i.e., any one or more of those UEs may perform sensing operations to generate sensing data, and may transmit the sensing data to the wireless network). As shown, UEs performing sensing operations may be within or otherwise near TSSA 402, e.g., within a suitable proximity to support the sensing activity. The wireless network (e.g., a CN thereof) may discover some (or all) UEs that are within or otherwise near TSSA 402, e.g., to cause at least one UE among UEs 404-407 to contribute to the group sensing. The wireless network may know locations of target UE 401 and of TSSA 402, but the wireless network may not know which UEs are within or otherwise near TSSA 402, complicating the process of discovering UEs to potentially participate in a group sensing task. In certain representative embodiments, the wireless network may know the locations of some, but not all UEs; for example, as shown, the wireless network knows the locations of UEs 404 and 405, without knowing the locations of UEs 406 and 407.

FIG. 4 shows how, in scenario 400 and in other representative embodiments, the TSSA 402 spans across the coverage of different respective cells of the wireless network (e.g., spanning three cells 403a-c, as shown in FIG. 4). UEs that can be discovered to participate in the sensing activity may be in the respective coverage zone of any one or more of these cells. However, the location of a UE at cell level may be known to the AMF only if the UE is in a connected mode (i.e., the UE is not in an idle mode, an inactive mode, or any other comparable mode in which the UE does not actively send location data to the network). If the UE is inactive or idle, the UE location is only known at the radio notification area (RNA) or tracking area (TA) levels, not at the cell level (e.g., the location is known at a coarse granularity, rather than a fine granularity). Certain core networks may be configured so as to not trust the location information of a UE while that UE is not in a connected state. As a result, certain network configurations may be inherently limited in their ability to discover all UEs within or otherwise near a TSSA.

Certain representative embodiments of this disclosure may provide methods, systems, and related approaches for discovering all UEs (e.g., including those that are and are not connected to a CN) within or otherwise near a TSSA. As part of this discovery approach, processes may be provided for a wireless network to identify all UEs within or near to a TSSA (e.g., that may be pinned to a target UE or otherwise to a specific coordinate space).

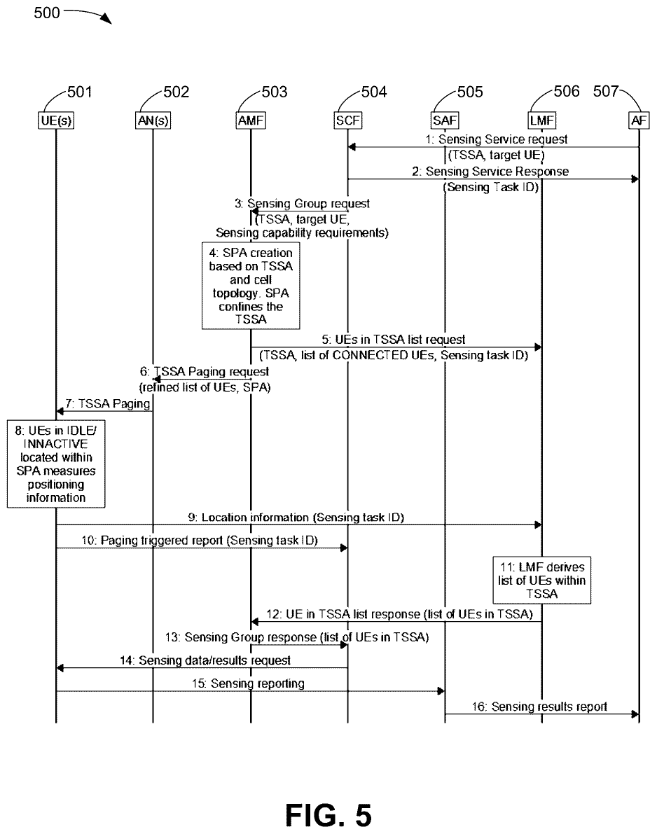

With reference to the annotations of FIGS. 5-7 and their corresponding descriptions, the names shown for any messages, and the specific contents of the messages, are merely illustrative of one possible implementation. Various functions are annotated in and described in connection with each of FIGS. 5-7 to better illustrate the corresponding processes; any other functions, devices, messages, processing, and/or sequence of operations can be used, so long as the same objectives are served. Thus, the specific functions sending/receiving messages, and the specific functions processing contents of those messages, are merely illustrative of one possible implementation. Independent of any evolution to the current 5G system, to any system operating under a current or future wireless standard, to any non-standardized wireless system, or to any other suitable wireless network, the objectives, outcomes, and fundamental operations of illustrative processes 500, 600, and 700 can be applied.

FIG. 5 is a flow diagram of an illustrative process 500 for discovering a UE that is not actively sharing its location information to a wireless network, and then causing that UE to perform sensing operations, in accordance with some embodiments of this disclosure. Method 500 illustrates an example of a procedure for discovering multiple UEs within a TSSA (e.g., using an LMF to determine a list of UEs in a TSSA).

Additional details on how to generalize illustrative process 500, and other representative embodiments of this disclosure, are provided below.

As shown, process 500 includes respective functionalities at one or more UE 501, one or more access node (AN) 502, an AMF 503, a SCF 504, a SAF 505, an LMF 506, and an AF 507; each of these components as described in connection with process 500 may be the same as a corresponding component mentioned in any of FIGS. 1-4, or anywhere else in this disclosure. As described, the TSSA may be TSSA 402, or any other suitable TSSA.

Steps of process 500 are described as follows, with reference to the annotated step numbers and details shown in FIG. 5.

At step 1 of process 500, SCF 504 receives a sensing service request. The sensing service request contains information relevant to the sensing (e.g., the TSSA and/or the target UE ID to which the TSSA may be pinned). Though shown as originating at AF 507 and being received at SCF 504, the sensing service request message can originate at and be received at any suitable node of a wireless network (e.g., including, but not limited to, a target UE, which may or may not correspond to one of UE(s) 501). The information relevant to the sensing may describe the TSSA, e.g., using a suitable measure of length to represent a threshold proximity. This information describing the TSSA may be processed at a UE 501 to determine whether that particular UE 501 is within the threshold proximity of the target UE and thus should be considered for participation in a group sensing task based on the TSSA.

At step 2 of process 500, SCF 504 replies to the message received at step 1 with a sensing service response (e.g., that may include a sensing task identification (ID), and/or any other suitable information).

At step 3 of process 500, SCF 504 requests from AMF 503 a sensing group (e.g., a list of UEs 501 within or sufficiently close to the TSSA). This sensing group request may include the information that describes the TSSA, a target UE ID, sensing availability (e.g., including sensing capability requirements as further described below, any other suitable details, or any combination thereof). The sensing capability requirements may be received at step 1 or may be determined based on processing of other information included in the sensing service request. Examples of sensing capability requirements are sensing KPIs, some of which can be found in in the 3GPP Service requirements for Integrated Sensing and Communication; Stage 1 (Release 19). In certain representative embodiments, sensing capability requirements may be derived by SCF 504. More details on how the SCF 504 may manage the sensing task, including its parsing of a list of UEs 501, are provided below, at least with respect to the discussion around the refinement of the list of UEs to page. The determined sensing capability requirements may help reduce the search space for finding UEs (e.g., by the AMF or any other suitable function), and it helps determining a refined, smaller list of UEs to be used in step 5 of process 500.

At step 4 of process 500, AMF 503 uses the received information about the TSSA (e.g., the size and/or shape of the TSSA), as well as knowledge of the cell topological deployment in and around the TSSA, to derive a sensing paging area (SPA). The SPA may refer to any number of wireless network cells to which a message (e.g., a broadcast message) is sent. For example, the message may be used to identify inactive or idle UEs. The message may be characterized as a broadcast message because it may not be specific to any one particular UE. Additional details that can relate to step 4 of process 500 are provided below, at least with the discussion around SPA definition and relation to the paging procedure.

At step 5 of process 500, AMF 503 sends a request to LMF 506 to receive a list of UEs within the TSSA. The request may include information that describes the TSSA, such as a list of connected UEs (e.g., UEs that are actively communicating location information to the AMF and/or the LMF, i.e., UEs that are not inactive or idle). The TSSA information can help the LMF to determine which UEs are inside of the TSSA or not (with more details on this determination provided in step 8 of process 500). The list of connected UEs may also be included in the list request. The list of connected UEs may represent a list of UEs that the AMF knows are in connected mode in cells belonging to the SPA. This information enables the LMF to derive a list of UEs that are in connected mode within the TSSA, from the list of UEs that are in connected mode within the SPA. This message may include an indication of a particular sensing task or activity identifier (e.g., to be used in the sensing that is reported in step 15 of process 500), which can help the LMF distinguish between other requests from the AMF and to identify UEs that may be able to support the sensing task

At step 6 of process 500, AMF 503 sends a request to one or more ANs 502 within the SPA, the request including a list of UEs. That list may be a refined list (e.g., indicating a prioritization or refinement of the list of connected UEs) of UEs. Additional details on how to refine a list of UEs are provided below, at least in connection with process 600 and related discussions around UE paging list refinement. If the request at step 6 of process 500 message reaches only one AN 502, but the SPA includes wireless cells of more than one AN 502, then the receiving AN 502 will propagate the message to the remaining ANs 502 via any suitable AN-AN interface. In this case, the receiving AN may be informed (e.g., based on an indication in the TSSA paging request) of which other ANs to propagate the message to. For example, AMF 503 may send the SPA information as e.g., a group of cells and/or Ans. For another example, the SPA knowledge may be shared based on a mapping of SPA to cell/AN IDs, or vice versa.

At step 7 of process 500, the one or more ANs 502 send a paging indication to the refined list of UEs. Additional details on the potential contents of this message are provided below, at least in connection with the discussion around paging request and UE behavior upon reception of the paging request.

At step 8 of process 500, UEs 501 receive the paging message and, based on receiving the message, determine their need to (or ability to) participate in the sensing activity. This determination may be based on measuring and providing their accurate positioning information (e.g., with precision to locate the UE within a specific wireless network cell). Measuring accurate positioning information may include generating the location information using any suitable process, including but not limited to those described in disclosure. This generation of location information be done via any positioning approach considered in the 3GPP's Stage 2 functional specification of User Equipment (UE) positioning in NG-RAN (Release 18), or any other suitable positioning method (e.g., that may be incorporated in future wireless network specifications). Additional details on potential approaches for generating and/or transmitting location information are provided below, at least in connection with the discussion around paging request and UE behavior upon reception of the paging request.

At step 9 of process 500, certain UEs 501 that received the paging message of step 6 transmit location information to the LMF 506. This location information may include some form of sensing task or activity identifier, any suitable sensing capability information, or any combination thereof, that can help the LMF distinguish between other requests from the AMF. For example, the location information may include an identifier received in step 7.

At step 10 of process 500, the UE 501 transmits a paging triggered report to the SCF 504. Though location information is typically sent, the paging triggered report could be transmitted regardless of whether location information is sent to the LMF (e.g., the paging triggered report could include a message that the UE is not authorized to or not able to send location information). Additional details on the potential contents of the paging triggered report are provided below, at least in connection with the discussion around paging request and UE behavior upon reception of the paging request.

At step 11 of process 500, the LMF 506 has all information needed to derive the list of UEs 501 within the TSSA. This information includes knowledge of the TSSA and location information (e.g., which may be derived or directly received) from all UEs 501, regardless of their connected/inactive/idle state. With this information, LMF 506 can determine whether the UEs 501 are within the TSSA or not via geometrical assessment, regardless of the coordinate system used.

At step 12 of process 500, LMF 506 sends a list of UEs 501 within the TSSA to AMF 503.

At step 13 of process 500, AMF 503 sends the derived list of UEs within the TSSA to the SCF, as a response to the request from the SCF in step 2.

At step 14 of process 500, SCF 504 may determine to request sensing data and/or sensing results from at least one UE 501. The at least one UE is within or sufficiently close to the TSSA to support sensing of the target.

At step 15 of process 500, the UE 501 transmits sensing data (e.g., packaged as sensing reports) to SAF 505. Step 15 of process 500 may also include UE 501 receiving a request from the wireless network to provide the sensing data, where the request was based on the sensing capability information (or any other suitable information of the paging triggered report transmitted at step 10 of process 500). Step 15 of process 500 may also include UE 501 performing sensing operations (e.g., based on receiving the sensing request) to generate the sensing data.

At step 16 of process 500, SAF 505 reports the sensing results to AF 507. This step may consider use a NEF for sharing the sensing results with the AF.

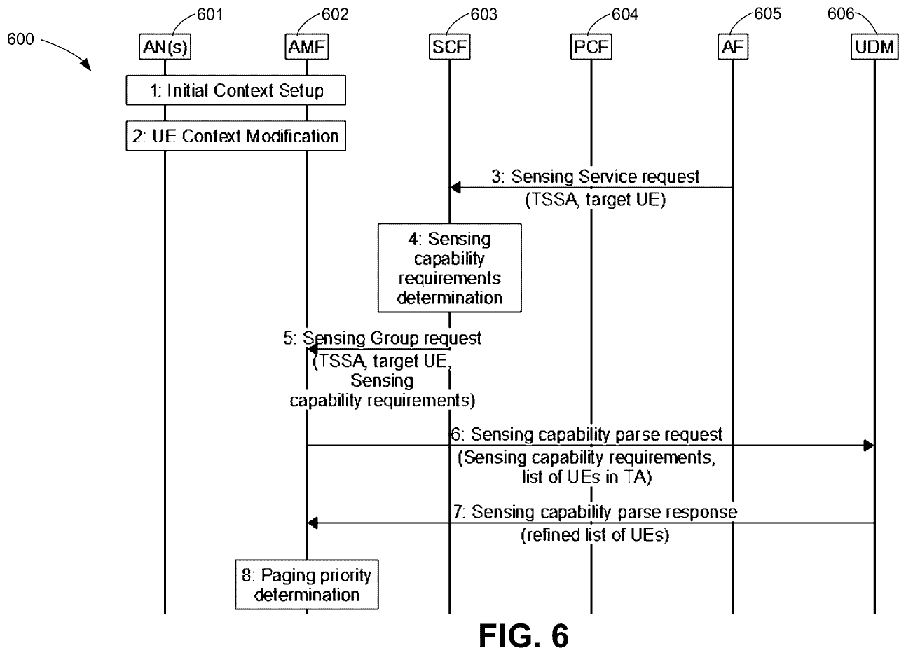

FIG. 6 is a flow diagram of an illustrative process 600 for prioritizing UEs to use in a sensing task, in accordance with some embodiments of this disclosure. Illustrative process 600 may correspond to UE paging list refinement, as mentioned above. That is, additional details surrounding UE paging list refinement are provided as follows. As used herein, paging list refinement may refer to reducing a list of UEs to be paged (e.g., based on the list at step 5 of process 500, and in connection with the paging request at step 6 of process 500).

As shown, process 600 includes respective functionalities at one or more AN 601, an AMF 602, a SCF 603, a SAF 604, an AF 605, and a unified data management (UDM) function 606; each of these components as described in connection with process 600 may be the same as a corresponding component mentioned in any of FIGS. 1-5, or anywhere else in this disclosure. Moreover, process 600 includes respective messages and illustrative components of information included in at least one of those respective messages; each respective message (and component thereof) as described in connection with process 600 may be the same as a corresponding message (or a corresponding component thereof) as described in connection with process 500.

At steps 1 and 2 of process 600, respectively, an initial context setup and a UE context modification occur at AN 601 and AMF 602. With these steps, the AMF 602 may receive information about the UE state (e.g., as connected, idle, inactive, or any other suitable state) from an AN 601 and for any given UE (e.g., any UE 501). Steps 1 and 2 of process 600 are included to illustrate one possible example for how an AMF may know about a UE state.

At step 3 of process 600, a sensing service request is received by SCF 603. This step may be similar to, or the same as, step 1 of process 500.

At step 4 of process 600, SCF 603 determines the sensing capability requirements for UEs to participate in the sensing activity. These requirements will permit the SCF 603 to refine (i.e., reduce) the total number of UEs to be paged in connection with process 500. This refinement may be made based on certain UEs not satisfying some or all of the sensing requirements of a given task. For example, a UE may be removed from a list because it does not possess a certain sensing capability, or because the UE has made (and transmitted) a self-determination that it is not suitable for the sensing activity (e.g., due to low battery, limited bandwidth, poor sensor operation, security limitation, subscription limitation, any other factor, or any combination thereof). Additional details on reducing the length of a list of UEs to page are provided below, at least in connection with the discussion around refinement of list of UEs to page.

At step 5 of process 600, SCF 603 sends a request to AMF 602 to receive information about the sensing group within the TSSA. This step may correspond to step 2 of process 500.

At step 6 of process 600, AMF 602 sends a request to UDM 606 to parse a list of UEs based on the sensing capability requirements. The list of UEs indicated in the message may be a full (i.e., unrefined) the list of UEs in a TA. However, this only an example, and additional details on reducing the length of a list of UEs to page are provided below, at least in connection with the discussion around refinement of list of UEs to page.

At step 7 of process 600, UDM 606 parses the received list of UEs with the sensing capability requirements and sends a refined list of UEs to the AMF 602. Step 7 of process 600 may include UDM 606 using the requirements determined at step 4 of process 600 and communicated in the intervening step as a sensing capability requirement. Again, additional details on reducing the length of a list of UEs to page are provided below, at least in connection with the discussion around refinement of list of UEs to page.

At step 8 of process 600, AMF 602 determines priority related settings for the refined list of UEs. Being independent of steps 6 and 7 of process 600, AMF 602 may not rely on UDM 606 for assigning paging priority to the UEs, only to refine a list of UEs. Additional details on the prioritization are provided below, at least in connection with the discussion around refinement of list of UEs to page. As used herein, a refinement (with reference to a list) may refer to reducing a number of UEs on a list (e.g., to reduce a number of paging signals that are sent out, or to otherwise reduce processing complexity at a network node). A prioritization (with reference to a list) may refer to ranking a list of UEs based on which UEs are best suited to support a sensing task. A prioritization may occur on a refined list, as shown at step 8 of process 600, and a prioritization may also occur on an unrefined list.

Additional details about how these procedures may be generalized to any current or future wireless standard, or any non-standardized wireless network, or to any other wireless network, are provided as follows. These additional generalization principles are described herein and are pertinent to the entirety of this disclosure.

Some possible trends in network development indicate functionality-based entities. These entities can be based in either hardware or in software (e.g., as virtualized entities), and might replace any of the entities described in this disclosure. For example, functionalities that are described in this disclosure as being executed by the AMF may be separated and distributed into other system entities. If that were to occur, then other entities containing the functionality of a current AMF may be communicating with entities that currently communicate with the AMF, and/or those other entities may communicate with different entities from the AMF. Whether or not new entity interfaces are made, and no matter how respective functionalities are distributed, certain representative embodiments of this disclosure may be preserved.

Some possible trends in network development indicate that all nodes or entities (e.g., of any suitable service-based architecture, or of any other related implementations, including, but not limited to, possible implementations of a 6GS) may communicate with all other entities, e.g., to enable diverse opportunities for functional distribution across a wireless network. The specific embodiments described in this disclosure, including the specific communications between network entities and the specific functionalities of various network functions/devices, should be regarded as illustrative examples. The specific communication schemes between entities described in this disclosure should be regarded as illustrative communications between certain functionalities that may be distributed in any suitable way across a wireless network (e.g., distributed as shown in an illustrative example herein, or distributed in any other suitable manner). That is, some embodiments of this disclosure should not be restricted by which entity (e.g., among a UE, AN, AMF, SCF, LMF, AF, and/or UDM) performs a function, but rather by the functionality itself.

Provided as follows are generalizations related to a paging procedure. Method 500 describes a paging procedure to transmit a message to UEs, where the UEs may be triggered to perform additional steps based on receiving the message. Those UEs are said to be paged because they may be associated with a radio resource control (RRC) state that is either idle or inactive, paging procedures can be applied to request such UEs to transition to a connected state. However, embodiments of this disclosure are related to conditions related to the states, not the specific names of the states or the specific details of these states. The existing states are referenced for illustrative purposes, only. In general, a UE may operate in at least two states, including a first state in which the UE's location is not known (e.g., to within a single-cell or sub-cell granularity) and a second state in which the UE's location is known (e.g., to within a single-cell or sub-cell granularity) by the wireless network. As used herein, paging may be consistent with descriptions of paging in existing procedures; alternatively, paging as used herein may be consistent with any other approach to transmit any suitable message, e.g., to a particular area using any suitable targeted or broadcast approach.

Provided as follows are generalizations related to UE location information. For illustrative purposes, reference is made to three UE RRC states of the 5G specification: connected, inactive and idle; some embodiments of this disclosure may be based on operation in at least two of those states (i.e., in an inactive or idle state, and in a connected state), and other embodiments of this disclosure may be based on operation in any other suitable first and second states that affect the transmission of location information. An AMF may be informed of the UE RRC state via procedures in steps 1 and 2 of process 600, among other procedures. The location of the UE is known at different levels of granularity depending on its state as follows. For a connected state UE, the AMF knows the serving cell(s) of the UE. For an inactive state UE, the AMF does not know in which cell the UE is attached to, and its location is known at RNA level. For an idle sate UE, the AMF does not know in which cell the UE is attached to, and its location may only be known at a TA level. Typically, TAs and RNAs are areas defined by a group of cells. Usually, TA is a bigger area than an RNA, and an RNA is bigger than a single cell (e.g., any single cell 403). Future specifications may define new states and/or new sizes associated with current/new states. As shown in process 600, steps 1 and 2 may be used to derive possible UE location information at either cell, RNA or TA levels. However, this disclosure generally describes first and second states in which the location of a UE is unknown or known, respectively, at the level of a single wireless network cell. This determines whether or not the UE needs to be discovered; when the location is unknown at a cell level, then the UE typically needs to be discovered. These determination and discovery steps are independent of any UE state nomenclature, and are further independent of which entity of the wireless network is making the determination.

As mentioned above, SPA definition and relation to the paging procedure is further described as follows. SPA definition may be required because a TSSA is a definite geographical area and may not have a direct mapping to a single cell. For example, with reference back to FIG. 4, an SPA may include the respective areas enclosed by each cell coverage area 403a-c. As such, the SPA would enclose the TSSA, though the SPA may be configured to overlap with only some of the TSSA. SPA definition can be regarded as a first step to narrow the search space for UEs in the physical world (e.g., in connection with creating, refining, and/or prioritizing a list of UEs, e.g., for group sensing). It may be known that UEs that are not in coverage of the SPA are not sufficiently close to (or within) the TSSA. Therefore, the SPA may be used to limit the number of ANs and/or cells associated with UEs that are useful to discover.

The SPA can also be used to estimate the TSSA and the resources available to perform sensing. For example, if the SPA confines the TSSA, then the wireless network can create an understanding of e.g., which AN nodes are available for sensing in the TSSA.

The AMF can create the SPA based on knowledge of the TSSA (e.g., its physical dimensions), and on knowledge of the AN cell topology. This topology can either be known to the AMF, collected from operator-owned topology databases, or retrieved from any other entity that knows the cell topology.

The AMF or any other node in the system, including any UE, may be configured to enlarge the TSSA, e.g., to provide sufficient coverage for finding UEs and/or ANs in the vicinity of the original TSSA. This enlargement may occur based on knowledge of the AN topology.

The SPA may also be described in relation to the abovementioned paging procedure as follows. The SPA describes a new area where paging will occur. This means that when the AMF requests paging of UEs to one or more ANs, this request may only be propagated within ANs covering the SPA; it may not be propagated to other ANs that are not part of the SPA. Such a configuration minimizes signal overhead, by avoiding, e.g., the paging of an entire TA.

As mentioned above, paging request and UE behavior upon its reception is further described as follows. This description may be used in connection with steps 5-9 of process 500, and it may be used in connection with any other aspect of this disclosure.

In step 6 of process 500, an SPA is communicated to one or more ANs. Upon reception of the SPA, the one or more ANs need to be able to translate the SPA to the cells that form the SPA. There are multiple options for how this transmission can be occur, several of which are described as follows.

If the AMF sends SPA related information to one AN, the receiving AN needs to know the other ANs to which it has to propagate the paging request. For example, if the SPA is identifiable by means of an SPA ID, then the ANs must have prior knowledge of the group of cells that constitutes the SPA. By mapping the SPA ID to the knowledge of the cells that constitute the SPA, the AN may be configured to only forward the request to the related ANs (e.g., those covering the SPA).

If instead of a form of SPA identifier, a group of cells or ANs is used, then the AMF may send the SPA to one AN that further forwards to other ANs, based on the cell IDs and/or AN IDs, or the SPA may send the SPA to each AN included in SPA, in which case there is no need to forward the message. If there is more than one AN receiving the paging request, then the full list of UEs could also be distributed such that each AN only receives a list of UEs within its respective cell coverage area (e.g., as further described below, in connection with the transmission of the list of UEs to ANs).

A paging request to the ANs may contain paging timing information, a maximum number of paging occasions the AN shall attempt to page one or more UEs, other suitable paging information, or any combination thereof. If timing information is included, it could tell the ANs a duration for which they can continue to try to page any one or more UEs. The timing information can therefore be associated with a single UE or with a group of UEs. If included, the maximum number of paging occasions could tell the AN how many attempts to page any one or more UE can occur. If a UE does not respond within a maximum number of paging attempts, then it may be dropped from a list of UEs that can support the group sensing task.

Additional details of transmitting a list of UEs to one or more ANs are described as follows. There may be different options for the transmission of the list of UEs to ANs. For example, the refined list of UEs can contain UE identities as individual entities; the refined list of UEs can contain groups of UE identities; or the refined list of UEs can contain one or more groups for certain UEs, and independently identify other UEs as separate entities. In a prioritized list, both groups and individual UE IDs can have a prioritization marker (e.g., a numeric ranking, a binary indicator, a flag, or any other suitable priority information) associated with them. Prioritization may apply to one or more individual UEs, and one or more groups of UEs

To distribute UE entities and UE groups to different ANs, there are various possible options. For example, both the UE entities and the UE groups may be distributed to all the ANs. This configuration may be applied for maximum likelihood of success, as all ANs would try to reach all UEs in the list (at the cost of greater transmission signal overhead). Alternatively, a full list of UE entities (which, again, may be UE groups, individual UEs, or a combination thereof) can be distributed in parts to one or more ANs, each AN receiving a part of the list based on its cell coverage area. The UEs can be shared based on cell coverage area according to any of the following criteria: the last known location of a UE belonging to a specific AN; the last known location of a UE in a group of UEs belonging to a specific AN; a particular UE, group of UEs, or subset of that group being usually located (as per any suitable determination, e.g., a statistical method) within a specific one or more Ans; high priority UEs or UE groups being distributed to all ANs, with lower priority UEs being distributed to specific one or more ANs; UEs or UE groups deemed high priority being the only ones transmitted to the ANs; or a time sensitivity, e.g., if time requirements are strict, more aggressive strategies (e.g., with greater signal overhead and less precision) are chosen, while less aggressive strategies are employed if time requirements are looser.

In certain representative embodiments, the message transmitting the list of UEs to the ANs may indicate an identity (or other information) of the sensing task.

Additional details of paging a TSSA are described as follows. Having received a list of UEs, one or more ANs can transmit the paging request for UEs with unknown locations. The paging request may be any suitable message, e.g., containing information that can cause the UEs perform corresponding actions (e.g., transitioning to a state in which the UE location is known). Both the information and the corresponding actions can be related to the sensing activity that is being configured. A description of the information that may be included in the paging request is provided as follows.

The TSSA Paging message may include a form of identity for the sensing task or activity. In other words, the message may include information that identifies, or describes, a sensing task or activity that needs to be performed.

The TSSA Paging message may include information that can be used by the UE to determine whether the UE is in the TSSA. For example, the TSSA paging message may include information that describes the location and/or size of the TSSA. For example, the UE may use the information that describes the TSSA to determine if the UE is close enough to the target UE to be considered part of the TSSA.

If the UE determines itself to be in the TSSA, then the UE may determine to respond to the paging message by generating a message at step 8 of process 500 e.g., by generating location information and preparing to transmit the UE's location information to the LMF or to any other suitable function of the wireless network.

If the UE determines that the UE is not in or sufficiently close to the TSSA, then the UE may determine to not respond to, or to negatively respond to the paging message. For example, generating the message at step 8 of process 500 may include generating an indication that the UE is in the PSA but not in the TSSA.

Whether or not the UE can participate in the sensing activity, it may transmit a message at step 9 of process 500. That message may include, or itself be, a report (e.g., to the SCF) indicating the conditions that caused the UE positively or negatively respond to the sensing request as transmitted by the TSSA paging.

Additional details of location information related to UE discovery is provided as follows. Depending on the UE state and configuration from the LMF, UEs may or may not have an active positioning configuration, allowing them to determine accurate positioning information, or information elements to deliver to the LMF so the LMF derives the accurate position of the UE. Hence, the paging message may contain instructions from the LMF to configure the UE for positioning. While an exchange between AMF and LMF is not depicted in process 500, such an exchange of information can occur between these functions, or any other comparable exchange of information can occur between two related nodes of the wireless system. The AMF can then include this information in steps 5 and 6, in the form of configuration or a pointer to a configuration. This operation only applies to UEs who do not have positioning configuration, as stated, but typically UEs in connected AND inactive have configured positioning resources. Another option for this operation is to include an indication for the UE to trigger a positioning request to the LMF, so that UE resources can be allocated as a response. Location information sent by the UE may contain any information already considered in the 3GPP's Stage 2 functional specification of User Equipment (UE) positioning in NG-RAN (Release 18).

Additional details of sensing task requirements are provided as follows. Sensing task requirements may relate to, or be indicated by, a sensing task ID (e.g., as sent in step 2 of process 500). Sensing task requirements may also relate to sensing availability information of a UE. That is, a UE may generate and/or transmit certain sensing availability information (e.g., using any one or more of steps 8-10 of process 500) based on knowledge of sensing task requirements associated with a given sensing activity.

The paging message may include information related to sensing requirements associated with a current or planned sensing activity. These requirements could be information that helps a UE determine the best action to take upon reception of the paging message. These requirements can be associated with individual UEs and/or groups of UEs. These requirements can be regarded as complimentary to the location information request to the UEs. That is, the UE may separately process the sensing requirements and the location information requirement, e.g., to transmit location information and sensing availability information. Sensing requirements may or may not apply based on a particular sensing use case.

Sensing task requirements may include sensing area requirements, sensing source requirements, sensing mode requirements, sensing range requirements, sensing task information timing requirements, or any combination thereof.

Sensing area requirements may include regulatory aspects, e.g., the TSSA is under regulation types A, B, and C, where A, B, and C, represent different sensing activities that are allowed or not allowed to occur; authorisation aspects, e.g., the TSSA is under authorisation policy D, E, or F, where D, E, and F represent different indications of authorizations that may be pre-established and to which the UE may need to adhere; and/or a type of sensing area, e.g., public or private domain. To further describe the type of sensing area, a sensing task may pertain to a sensing service in a public area, such that only UEs within a public area may accept the sensing task. For example, in the automotive sector, the target UE may be a vehicle and a UE in the paging list may be within the TSSA, but inside a building. In this case, there may be no need to have this UE joining the sensing activities.

Sensing source requirements may include a sensing source type, e.g., RF sensing, video, LiDAR, or any other sensor; and/or confidence levels of the sensing data per sensing source, e.g., 95% confidence for the video sensor, 96% confidence for RF sensing, or any other confidence level.

Sensing mode requirements may include an indication of the one or more preferred sensing modes for RF sensing, e.g., monostatic or bi-static; and/or confidence levels of the sensing data per sensing mode, e.g., 95% confidence for monostatic sensor, 96% confidence for bi-static, or any other confidence level.

Sensing range requirements may include a sensing range per sensing source type, e.g., a first range for video sensing, a second range for monostatic sensing, and a third range for bi-static sensing. There may be respective confidence levels associated with each of the one or more sensing sources.

Sensing task information timing requirements may include how long sensing will be required; when sensing will be required (if not immediately); periodic or aperiodic timing information associated with the duration of the sensing task, e.g., sensing will be needed between first and second times, which may periodically repeat until the end of the duration of the sensing task; and/or timing aspects related to UE actions. These timing aspects may relate to any of requirements given above (sensing area, source, mode, range requirements). These timing aspects may include a time limit for a response based on Sensing area requirements; a time limit for the assessment of the confidence of each of the one or more sensing sources; a time limit for the assessment of the confidence of each of the one or more sensing modes; and/or a time limit for the assessment of the confidence of each of the one or more ranges obtained for each of the one or more sensing sources.

Additional details of UE action determination are provided as follows. For example, the UE action determination may occur at step 8 of process 500, based on receiving the TSSA paging message (and optionally further based on particular information of the TSSA paging message).

Based on receiving the paging message, the UE can determine one or more actions to execute. As stated above, the UE may be configured to make this determination within a prescribed time limit. Whether a time limit is present or not, the UE may be configured to determine the action to take as quickly as possible.

A first action that the UE may perform is to generate location information about itself, and to provide that location information to the LMF. As mentioned, upon receipt of the paging message, the UE may or may not be in a state with an active positioning configuration enabled. If so, the UE can generate the location information by issuing a request to the LMF to request positioning resources. If the UE is in a state with an active positioning configuration enabled, then the UE may use that configuration to generate the location information, or the UE may still trigger a network resource to obtain its own location information.

In addition to the request to provide location information, the paging message may provide the UE with other parameters to consider, as described elsewhere. These parameters may cause the UE to determine that it should not participate in the sensing task. Accordingly, the UE may send an indication to the SCF of why it determined not to participate. Alternatively, if the UE determines it should participate in the sensing task, then it may transmit information to the SCF indicating why it determined to participate. The SCF may be configured to validate the determination based on that information.

To summarize these determination actions of the UE, the UE determines whether it should report on its location information to the LMF, and the UE further determines which information (e.g., including sensing availability information) to report to the SCF, based on the described requirements (e.g., of the paging message). The UE can transmit an initial report when informing the LMF of its position, and it can subsequently (or otherwise, in a single report) transmit a report with sensing availability information (e.g., which may indicate why a UE determined to make itself available for participation in a sensing task). Alternatively, the UE can transmit a report detailing the one or more reasons to have not reported its position to the LMF.

Additional details of UE reporting on its location information are provided as follows. For example, the UE may report on its location information at step 9 of process 500, based on a determination made at step 8 of process 500.

UE may send a message to the LMF (or any other node of the wireless network) containing its accurate location information, as triggered by the received paging message. This message may also include a form of identity of the UE, and/or a form of identity of the sensing task. The UE may further send its sensing availability, which may optionally include sensing availability information, to the wireless network.

The location information message from the UE may also include information that indicates its position in the TSSA. For example, the message may indicate a distance between the UE and Target UE that the TSSA is pinned to. This distance information may also indicate a direction relating the UE to the target UE. This distance information may also indicate relative location and relative velocity between the two UEs.

Additional details of UE transmitting a report (e.g., a page triggered report) based on receiving the paging message and based on providing location information are provided as follows. For example, the UE may transmit the report at step 10 of process 500, based on a determination made at step 8 of process 500, and further based on the location information transmission at step 9 of process 500.

The UE may use the received sensing requirements information to determine what to include in its report to the wireless network. The UE may be configured to transmit this report within a time limit indicated in the paging message. Examples of contents that may be included in this report include sensing area requirements, sensing source requirements, sensing mode requirements, and/or sensing range requirements.

Sensing area requirements may include an indication of the regulatory area where the UE is at the moment, or an indication that the regulatory area is not allowing the UE to participate in the sensing activity; an indication of the authorization policy related to where the UE is at the moment, or related to user consent authorization being present or not, or an indication that the authorization policy is not allowing the UE to participate in the sensing activity; and/or an indication of the type of sensing area where the UE is at the moment, or an indication that the type of sensing area precludes the UE from joining the sensing activity.

Sensing source requirements many include sensing source type availability indication, e.g., indicating that one or more sensors are or are not available, e.g., due to a HW or SW fault; and/or confidence levels of the sensing data (e.g., based on one or more respective sensing sources).

Sensing mode requirements may include an indication of the availability to perform monostatic and/or bi-static sensing, an indication of the bands available for each mode, or a request for bi-static resources setup; and/or confidence levels of the sensing data (e.g., based on one or more respective sensing modes).

Sensing range requirements may include an indication of the sensing range per sensing source type, e.g., a first range for video data, a second range for monostatic data, and a third range for bi-static data. Sensing range requirements may further include respective confidence values for each of the one or more sensing sources (e.g., 95% confidence for the first range for video)

The transmitted report may also include a form of identity for the UE and/or for the sensing task

As mentioned above, additional details about refinement of lists to UEs (e.g., reducing the number of UEs in a list) to page are provided as follows. These additional details provide examples of how an initial list of UEs can be refined before being paged, to reduce signal overhead and to maintain power savings on UEs by not paging them unnecessarily. The refinement may be based on UE characteristics that relate to ongoing or planned sensing activities.

As part of this refinement, UE capabilities may have been registered within the wireless network (e.g., with the UDM or any other suitable network function), such that there is a network entity containing lists of UE characteristics. Accordingly, in the illustrative example of process 600, the AMF sends an initial list of UEs to the UDM, and the UDM returns a refined list (which may otherwise be referred to as a parsed list) of UEs.

When generating the initial UE list, the coarsest location granularity may be the AMF knowing UE locations at TA level. The area of a TA can be significant, e.g., the entirety of a city. Thus, the initial list may contain all UEs within a TA, which could be many UEs. The AMF may apply heuristic models or any other suitable process to reduce the size of this list (i.e., to refine the list). This refinement can be based on, e.g., the typical location of UEs based on their prior location data. This refinement can also be based on mobility patterns and times of the day and/or week, e.g., such that the AMF may estimate a UE to be located inside or outside of the SPA based on typical pattern movements of the UE. For example, it may be known that the UE operates in a connected state from within the same cell for a portion of every day of the week.

Parsing the initial UE list can be based on several factors, including UE type, sensing capabilities, sidelink capabilities of the UE, and/or UE category.

UE type may identify details of the UE. UE types may include a connected vehicle, a robot, an IoT or RedCap device, a smartphone, or any other wireless-enabled device. Identifying the UE type can help with including or excluding a UE from the list, e.g., to exclude an IoT device if the wireless system is trying to establish sidelink connections between autonomous vehicles. For another example, in a factory setting, a smartphone may be deemed not useful for a given sensing activity

Sensing capabilities may include sensing source types, sensing mode capabilities, sensing source and sensing mode confidence levels, and/or sensing area requirements. Sensing source types may indicate sensing data types the UE can provide, e.g., a video stream for sensing, an image, LiDAR sensing data, RF sensing capabilities on specific bands or smaller frequency intervals, audio data, or any other suitable information. Sensing mode capabilities may indicate whether the UE is capable of monostatic, bi-static, and/or multi-static sensing; for example, some UEs may be able to act as a sensing receiver but not as a sensing transmitter, and this functionality may be indicated in a sensing mode capability. Sensing mode confidence levels may indicate whether the is UE capable of providing extreme sensing confidence levels, e.g., above 98% confidence or any other suitable confidence. Sensing range requirements may indicate whether the UE's sensing range (e.g., for each of multiple possible sensing source types) exceeds a certain threshold distance; there may be a confidence level associated with the threshold distance (e.g., the distance may be shorter for higher confidence levels, and vice versa). Sensing area requirements may indicate regulatory, authorization, sensing area, and/or consent aspects pertaining to the UE, e.g.: whether the UE under regulations A, B, and/or C; whether the UE is under authorization policy D, E, and/or F; whether the UE is in a public area, private area, or both; and/or whether explicit consent is provided by a user, owner, or operator of the UE to participate in sensing activities.

Sidelink capabilities of the UE may indicate whether the UE is sidelink capable (e.g., capable of performing any direct UE-to-UE communication), including which frequency bands can be used by the UE to communicate, and whether the UE can transmit sidelink messages, receive sidelink messages, or both.

UE category may indicate frequencies supported for sidelink or other communication by the UE, e.g., an indication of whether the UE is capable of certain frequency bands and/or information that indicates which frequency bands can be used by the UE to communicate; frequencies supported for sensing by the UE, e.g., an indication of whether the UE is capable of certain frequency bands for sensing, and/or information that indicates which frequency bands can be used by the UE to perform sensing; multiple-input multiple-output (MIMO) capabilities supported for sensing by the UE, e.g., an indication of whether the UE is capable of using a certain number of antennas and MIMO configurations for sensing, and/or information that indicates which antennas and MIMO configurations can be used by the UE to perform sensing; the power class of the UE, e.g., an indication of what is the required UE power class in general and/or for sensing, and/or information that indicates which power class or transmit power requirements that can be used by the UE to perform sensing or any other suitable function; positioning processes supported by the UE, e.g., an indication of whether the UE supports positioning, including specific positioning processes available to the UE, and/or information that indicates which positioning processes can be used by the UE to perform sensing or any other suitable function; and/or a maximum upload (UL) and/or download (DL) throughput capacity of the UE, e.g., an indication of maximum UL and DL data rates, and/or information that indicates whether a maximum data rate applies to communications, sensing, other operations, or any combination thereof.

In certain representative embodiments, an AMF may indicate one or more of specific characteristics related to parsing the list, and the UDM may use those specific characteristics to refine the list (i.e., to determine whether or not to include a UE in the refined). However, as mentioned throughout this disclosure, any suitable nodes, functions, devices, or entities, or any combination thereof, of the wireless network may perform some or all of these tasks instead of the AMF or the UDM.

As mentioned above, prioritization of UEs and/or UE groups may also occur. For example, an AMF can create any group of UEs based on any one or more of the characteristics used for parsing the list of UEs. Depending on the sensing activity, some of these characteristics may be more important than others for prioritization.

It is possible that an LMF (or other similar network function) is unavailable (e.g., an operator is not deploying the LMF, hardware is down, there is overload on the LMF, any other suitable cause of unavailability, or any combination thereof). Provided below are procedures for executing certain embodiments of this disclosure when the LMF is wholly or partially unavailable, or otherwise when there is a failure of the aspect of the wireless network that supports the maintenance of accurate (e.g., within a coverage cell) location information for a UE.

Without an LMF, to identify UEs that are in the area around the TSSA, a wireless network may consider paging responses from UEs in the SPA to determine that those UEs represent a group of UEs in the area, without necessarily determining if the area is in the TSSA.

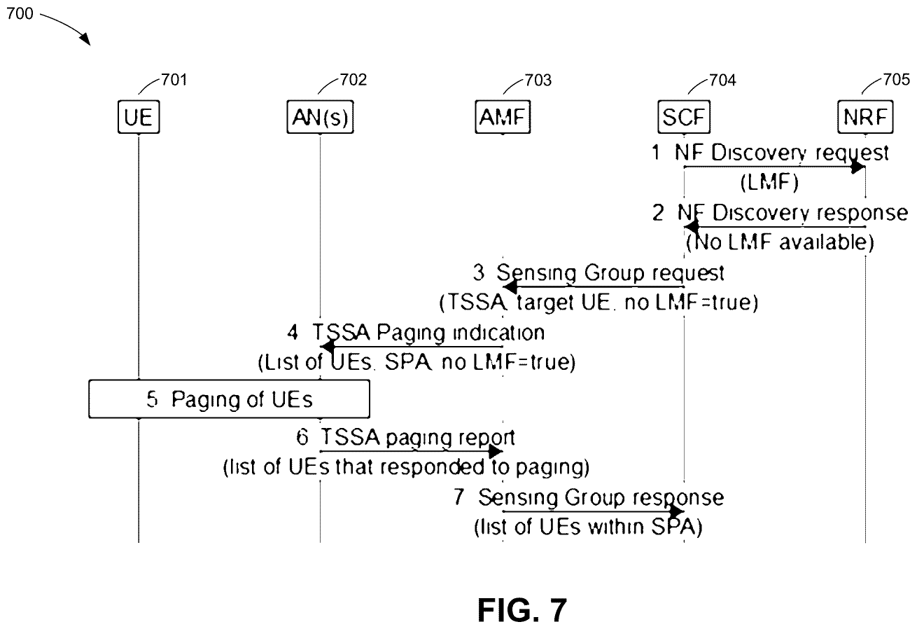

FIG. 7 is a flow diagram of an illustrative process 700 for discovering UEs in the absence of a location management function (LMF), in accordance with some embodiments of this disclosure. In other words, process 700 may be used for discovering UEs within an SPA without use of an LMF.

As shown, process 700 includes respective functionalities at UE 701, one or more AN 702, an AMF 703, a SCF 704, and a network repository function (NRF) 705; each of these components as described in connection with process 700 may be the same as a corresponding component mentioned in any of FIGS. 1-6, or anywhere else in this disclosure.

At step 1 of process 700, SCF 704 sends an NF discovery request to NRF 705, e.g., to request an LMF instance. This step may be configured to occur after step 3 of process 600.

At step 2 of process 700, because there is no LMF available, NRF 705 responds with an NF discovery response containing an indication that there is no LMF available.

At step 3 of process 700, SCF 704 sends a sensing group request to AMF 703, e.g., with the indication that no LMF is available. This step may be similar to step 5 of process 600, albeit with the indication that no LMF is available.

At step 4 of process 700, AMF 703 creates an SPA and sends a TSSA paging indication to the one or more Ans 702.

At step 5 of process 700, one or more ANs 702 page the list of UEs 701 as received from AMF 703. Based on receiving the paging message, the UE may trigger a state change from a first (e.g., inactive, or idle) state to a second (e.g., connected) state. If such a state transition occurs, happens, then the one or more ANs 702 are able to identify the UE 701 as being in the SPA.

At step 6 of process 700, the one or more ANs 702 send a TSSA paging report to the AMF 703. The report contains a list of UEs 701 that responded to the paging request. The list may be compiled based on detecting the state transition change in connection with step 5 of process 700, a related state transition message, or any other suitable indication.

At step 7 of process 700, AMF 703 communicates the received list from the one or more ANs 702 to the SCF 704 by sending a sensing group response including the list of UEs 701 within the SPA.

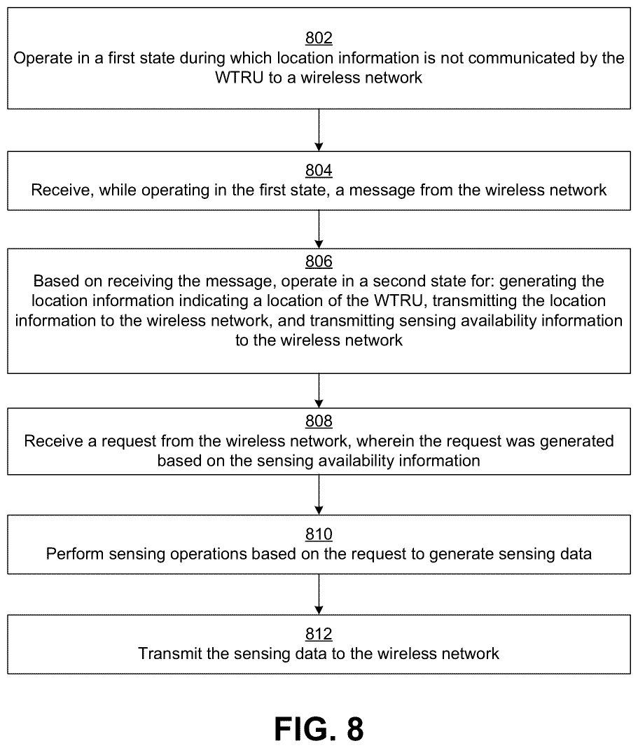

FIG. 8 is a flow diagram of an illustrative process 800 for sensing using a WTRU based on receiving a message from a wireless network while the WTRU is not actively communicating a location to the wireless network, in accordance with some embodiments of this disclosure. Method 800 may be performed by any WTRU or UE described in this disclosure, including, but not limited to, any WTRU 102, WTRUs 301-302, UEs 404-407, UE(s) 501, UE 701, and process 800 may be performed by any other WTRU or UE with sensing and communication capabilities. Method 800 may be performed based on communication with any suitable wireless network, including, but not limited to, a 5G system, any system operating under a current or future wireless standard, any non-standardized wireless system, any other suitable wireless network, the wireless network depicted in FIG. 1, or the wireless network depicted in FIG. 3. Method 800 may be performed based on operations by any suitable functions or domains of the wireless network, including, but not limited to, any of the functions or domains shown in FIGS. 1-7, or any other suitable functions or domains that are implemented in a wireless network.

At step 802, process 800 includes operating in a first state during which location information is not communicated by the WTRU to a wireless network. For example, the first state may be an idle or inactive state, as defined by the current 5G specification; however, the first state need not be either of those states, or any other state defined in the 5G specification or any other specification. Operating in the first state may simply mean that the WTRU operates within a cell coverage area of a wireless network while not actively providing location information of the WTRU to the wireless network. For example, operating in the first state may occur at a time preceding step 8 of process 500.

At step 804, process 800 includes receiving, while operating in the first state, a message from the wireless network. For example, the message could be a paging indication, e.g., including at least one of a location information configuration, a sensing task requirement, or a sensing task identification (ID). For example, step 804 may correspond to step 7 of process 500. Information of the message may include an indication of a target to be sensed.

At step 806, process 800 includes, based on receiving the message, operating in a second state for generating the location information indicating a location of the WTRU (e.g., which may correspond to step 8 of process 500), transmitting the location information to the wireless network (e.g., which may correspond to step 9 of process 500), and transmitting sensing availability information to the wireless network (e.g., which may correspond to step 10 of process 500). For example, the second state may be a connected state as defined by the current 5G specification; however, the second state need not be the connected state, or any other state defined in the 5G specification or any other specification. Operating in the second state may simply mean that the WTRU operates within a cell coverage area of a wireless network while actively providing location information of the WTRU to the wireless network. The sensing availability information may include a paging triggered report including at least one of a sensing area requirement, a sensing source requirement, a sensing mode requirement, a sensing range requirement, a sensing task identification (ID), or an ID of the WTRU. If information of the message includes an indication of a target to be sensed, then the sensing availability information may include a distance between the WTRU and the target.

At step 808, process 800 includes receiving a request from the wireless network, wherein the request was generated based on the sensing availability information. For example, step 808 may correspond to step 14 of process 800. For another example, describing the request at step 808 as being generated based on the sensing availability information may mean that steps 11-13 of process 800 occurred at the wireless network (e.g., at any suitable entity of the wireless network, which includes but is not limited to the functions shown in FIG. 5), causing the wireless network to send the request that is received at the WTRU at step 808. The WTRU may receive the message from the wireless network based on being within a tracking area (TA), where the tracking area includes at least one cell coverage area.

At step 810, process 800 includes performing sensing operations based on the request to generate sensing data. For example, step 810 may include the WTRU providing data from a radiofrequency (RF) sensor, video sensor, audio sensor, environmental sensor (e.g., detecting temperature, humidity, wind speed, ambient light, precipitation, or other environmental data), inertial motion sensor, or light detection and ranging (LiDAR) sensor of the WTRU. For example, the data may sense a target UE (e.g., target UE 401), which may be pinned to a TSSA (e.g., TSSA 402).

At step 812, process 800 includes transmitting the sensing data to the wireless network. Step 812 may correspond to step 15 of process 500.

As used herein, sensing task may be interchangeable with sensing activity, either of which may generally refer to performing sensing operations at a WTRU or a UE. A sensing task may be configured by a wireless network, e.g., based on a specific target UE, TSSA, or target sensing outcome.

As mentioned above, and as reiterated with reference to the claims which follow, first and second states of a WTRU are described with reference to whether the WTRU is not (e.g., in the first state) or is (e.g., in the second state) actively communicating location information to the wireless network. The first state may be an inactive or idle state, and the second state may be a connected state; however, neither of the first state nor the second state needs to correspond to any particular defined state (e.g., as may exist in any current or future specification). Rather, the first and second states simply represent two modes of operation in which location information is unknown, or known with a relatively low degree of granularity (i.e., low precision), in the first state, and location information is known with a relatively higher degree of granularity (i.e., higher precision, compared to that of the first state) in the second state.

Throughout the specification the phrases “in response to” and “based on” shall be understood to have a broad meaning unless stated otherwise. For example, “in response to” can refer to a step that is in direct or indirect response to a prior step, and “based on” can refer to a step that is based at least in part on a prior step.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent processes and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular processes or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only and should not be taken as limiting the scope of the following claims. For instance, the embodiments provided herein include handheld devices, which may include or be utilized with any appropriate voltage source, such as a battery or the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type of medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6, 35 U.S.C. § 112(f) or means-plus-function claim format, and any claim without the terms “means for” is not so intended.

What is claimed is:

1. A method performed by a wireless transmit/receive unit (WTRU), the method comprising:
operating in a first state during which location information is not communicated by the WTRU to a wireless network;
receiving, while operating in the first state, a message from the wireless network;
based on receiving the message, operating in a second state for:
generating the location information indicating a location of the WTRU,
transmitting the location information to the wireless network, and
transmitting sensing availability information to the wireless network;
receiving a request from the wireless network, wherein the request was generated based on the sensing availability information;
performing sensing operations based on the request to generate sensing data; and
transmitting the sensing data to the wireless network.

2. The method of claim 1, wherein operating in the first state comprises operating within a cell coverage area of the wireless network while not actively providing the location information to the wireless network.

3. The method of claim 1, wherein the message comprises a paging indication comprising at least one of: a location information configuration, a sensing task requirement, or a sensing task identification (ID).

4. The method of claim 1, wherein the sensing availability information comprises a paging triggered report comprising at least one of: a sensing area requirement, a sensing source requirement, a sensing mode requirement, a sensing range requirement, a sensing task identification (ID), or an ID of the WTRU.

5. The method of claim 1, wherein the WTRU receives the message from the wireless network based on being within a tracking area (TA), the tracking area comprising at least one cell coverage area.

6. The method of claim 1, further comprising determining, based on information of the message, that the WTRU can participate in a sensing task, wherein transmitting the sensing availability information comprises communicating the determination that the WTRU can participate in the sensing task.

7. The method of claim 1, wherein information of the message comprises an indication of a target to be sensed.

8. The method of claim 7, wherein the sensing availability information comprises a distance between the WTRU and the target.

9. The method of claim 1, wherein performing the sensing operations comprises providing data from a radiofrequency (RF) sensor, video sensor, or light detection and ranging (LiDAR) sensor of the WTRU.

10. The method of claim 1, wherein performing the sensing operations comprises calculating a confidence level associated with accuracy of the sensing data.

11. A wireless transmit/receive unit (WTRU) comprising processing circuitry and communication circuitry, the WTRU configured to:
operate in a first state during which location information is not communicated by the WTRU to a wireless network;
receive, while operating in the first state, a message from the wireless network;
based on receiving the message, operate in a second state for:
generating the location information indicating a location of the WTRU,
transmitting the location information to the wireless network, and
transmitting sensing availability information to the wireless network;
receive a request from the wireless network, wherein the request was generated based on the sensing availability information;
perform sensing operations based on the request to generate sensing data; and
transmit the sensing data to the wireless network.

12. The WTRU of claim 11, wherein to operate in the first state comprises operating within a cell coverage area of the wireless network while not actively providing the location information to the wireless network.

13. The WTRU of claim 11, wherein the message comprises a paging indication comprising at least one of: a location information configuration, a sensing task requirement, or a sensing task identification (ID).

14. The WTRU of claim 11, wherein the sensing availability information comprises a paging triggered report comprising at least one of: a sensing area requirement, a sensing source requirement, a sensing mode requirement, a sensing range requirement, a sensing task identification (ID), or an ID of the WTRU.

15. The WTRU of claim 11, wherein the WTRU is to receive the message from the wireless network based on being within a tracking area (TA), the tracking area comprising at least one cell coverage area.

16. The WTRU of claim 11, wherein the WTRU is further to determine, based on information of the message, that the WTRU can participate in a sensing task, wherein to transmit the sensing availability information comprises communicating the determination that the WTRU can participate in the sensing task.

17. The WTRU of claim 11, wherein information of the message comprises an indication of a target to be sensed.

18. The WTRU of claim 17, wherein the sensing availability information comprises a distance between the WTRU and the target.

19. The WTRU of claim 11, wherein to perform the sensing operations comprises providing data from a radiofrequency (RF) sensor, video sensor, or light detection and ranging (LiDAR) sensor of the WTRU.

20. The WTRU of claim 11, wherein to perform the sensing operations comprises calculating a confidence level associated with accuracy of the sensing data.
